(19) United States
(12) Patent Application Publication
(10) Pub. No.: US 2026/0005989 A1
(43) Pub. Date: Jan. 1, 2026

(54) Computer system for storing and sending instant sound-sticker messages over chats in messaging apps

(71) Applicant: Yotam Zakai, Ramat Gan (IL)

(72) Inventor: Yotam Zakai, Ramat Gan (IL)

(21) Appl. No.: 18/760,407

(22) Filed: Jul. 1, 2024

(51) Int. Cl. H04L 51/04; G06F 3/04886; H04L 51/10

(52) U.S. Cl. CPC H04L 51/04; G06F 3/04886; H04L 51/10

(57) ABSTRACT

A system for storing and sending instant sound-sticker messages over a chat in a messaging app that is configured to display on the touch screen of the user's smartphone a panel bar, display a sound-sticker keyboard that includes the instant sound-sticker messages that are integrated with a virtual keyboard or with a messaging app and saved on the user's smartphone, display a plurality of stickers in the sound-sticker messages keyboard that are linked to the instant sound-sticker messages, select an instant sound-sticker message upon selecting a sticker from the sound-sticker messages keyboard, upload the selected instant sound-sticker message with the selected sticker into the chat.

### TECHNICAL FIELD

The present invention refers to a computer system for storing and sending instant pre-prepared sound messages over a chat in a messaging app.

### BACKGROUND ART

There is a constant need to improve the communication between users in messaging apps and to increase the possibilities of emotional expressions sent over the chats and present invention discloses systems for enhancing the options to communicate over messaging apps.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1A is a schematic illustration of the user's smartphone.

FIG. 1B is a schematic illustration of the contact's smartphone.

FIG. 2 is a schematic illustration of the user's smartphone with stickers keyboard.

FIG. 3 is a schematic illustration of the system (100).

FIG. 4 is a schematic illustration of the system (200).

FIG. 5 is a schematic illustration of the system (300).

### THE INVENTION

In this disclosure and in the claims we use expressions as is customary in the field, but for the sake of clarity, we will specify and explain several terms, as follows: the term virtual keyboard (10) means keyboards that are displayed on the touch screens of smartphones for typing text to be sent over a chat. These keyboards may be pre-downloaded in the smartphone by the manufacturers or the suppliers, downloadable by the users, or keyboards that are a part of messaging apps; the term a writing spacebar (11) is the rectangular window in a virtual keyboard or in a messaging app in which the user type or enter text that he wants to send over the chat; the term a panel bar (12) means a row or rows or space of main icons, each of which opens another internal integral keyboard, which can be for example a stickers keyboard, a Gif keyboard, or emoticons keyboard; the term a stickers keyboard (13) means any keyboard that contains stickers, GIFs, emoticons, images or files that are an integral part of the virtual keyboard or an integral part of the messaging app. The term stickers in disclosure and in the claims means stickers, Gifs, emoticons and images that are sent from the keyboard over the chats of the messaging apps.

The main objective of the present invention is to provide a computer system (100) computer system for storing instant pre-prepared sound-sticker messages (101) and for sending a selected instant pre-prepared sound-sticker message (102) over a chat (59) in a messaging app from a user's smartphone (51) to a contact's smartphone (55).

The system comprises a processing device (52) in the user's smartphone that is configured to:

Display by the processing device on a touch screen (53) of the user's smartphone a panel bar display (12) that is integrated with a virtual keyboard (10) or with the messaging app.

Display by the processing device on the touch screen of the user's smartphone a main sound-sticker icon (104) on the panel bar display.

Display by the processing device on the touch screen of the user's smartphone an instant pre-prepared sound-sticker messages keyboard (105) that is integrated with the virtual keyboard (10) or with the messaging app. The instant pre-prepared sound-sticker messages keyboard may be opened when tapping on the main sound-sticker icon (104).

Save by the processing device on the user's smartphone the instant pre-prepared sound-sticker messages in the instant pre-prepared sound-sticker messages keyboard. The instant pre-prepared sound-sticker messages are files of sound that may be for example MP3 or MP4 combined with a sticker. The sound may be for example music, sound of nature, machines, animals, human voices, or effects of instruments. The term sticker in this regards in this disclosure and the claims means any visual sign or graphic such as icons, stickers, images and animations.

Display by the processing device on the touch screen a plurality of stickers (106) in the instant pre-prepared sound-sticker messages keyboard. Each sticker (106) is linked to an instant pre-prepared sound-sticker message (101) of these instant pre-prepared sound-sticker messages. It is possible and preferable that each sticker will have a unique visual design to enable the user to select the instant pre-prepared sound-sticker message he wants to send over the chat, and also to enable to fit the sound to the visual graphic of the sticker to express the feelings of the sender.

Select by the processing device the selected instant pre-prepared sound-sticker message upon a tapping action on a sticker (1061) in the instant pre-prepared sound-sticker messages keyboard that is linked to the selected instant pre-prepared sound-sticker message (102).

Upload by the processing device the selected instant pre-prepared sound-sticker message (102) (directly or indirectly) into the chat (59). This upload configured to cause the user's smartphone to send the selected instant pre-prepared sound-sticker message to the contact's smartphone over the chat. Alternatively, upload by the processing device the selected instant pre-prepared sound-sticker message into the writing spacebar (11) of the messaging app or of the virtual keyboard that enables the user to send the selected instant pre-prepared sound-sticker message to the contact's smartphone over the chat. The system (100) may further include a play symbol (400) on the sound-sticker message to notify that this sound-sticker includes sound. It is preferable that instant pre-prepared sound-sticker messages will be displayed on the screen of the smartphone as a sticker with the play symbol (400).

Another embodiment of the present invention refers to a computer system (200) for creating a combined voice-sticker message (201) that is designed to be sent over the chat in the messaging app from the user's smartphone to the contact's smartphone. The system (200) comprises the processing device in the user's smartphone that is configured to: Display by the processing device on the touch screen of the user's smartphone panel bar display that is integrated with the virtual keyboard or with the messaging app. Display by the processing device on the touch screen a main stickers icon (14) on the panel bar display. Display by the processing device on the touch screen the stickers keyboard (13) that is integrated with the virtual keyboard or with the messaging app. Display by the processing device on the touch screen a plurality of stickers (15) in the stickers keyboard. Display by the processing device on the touch screen a recording-combining button (202) that is configured to record a voice message and to combine the recorded voice message with a selected sticker (203) for creating the combined voice-sticker message (201). It is possible and preferably that each sticker comprises the recording-combining button that is configured to record the voice message and to combine the recorded voice message with the selected sticker used to record the voice message for creating the combined voice-sticker message. Upload by the processing device the combined voice-sticker message directly into the chat. This upload constitutes an action of sending the combined voice-sticker message to the contact's smartphone over the chat. Alternatively, upload by the processing device the combined voice-sticker message into the writing spacebar of the messaging app enables the user to send the selected combined voice-sticker message to the contact's smartphone over the chat. The system (200) may further include a play symbol (400) on the combined message (201) to notify that this sticker is also a voice message.

It is possible and preferable that each of the plurality of stickers comprises the recording-combining button that is designed to be activated upon a first style tapping action, and also comprises a sticker plain send button (204) that is designed to be activated upon a second style tapping action (different of the first style). By that, each sticker can be sent over the chat upon the first style taping action and it is sent as a sticker (as a sticker without sound), and in addition to that, each sticker is designed to be sent over the chat as a part of the combined sticker-voice-message upon using second style taping action. For example, the user can touch the sticker and it will be sent over the chat or to touch it long touch to record the voice message and to make the combining and sending steps.

Another embodiment of the present invention refers to a computer system (300) for creating a combined voice-image message (301) that is designed to be sent over the chat in the messaging app from the user's smartphone to the contact's smartphone. The system (300) comprises the processing device in the user's smartphone that is configured to: Display by the processing device on the touch screen of the user's smartphone a selected image (302). Display by the processing device on the touch screen a recording-combining button (303) that is configured to record the voice message and to combine the recorded voice message with the selected image for creating the combined voice-image message. Upload by the processing device the combined voice-image message into the chat. The upload constitutes an action of sending the combined voice-image message to the contact's smartphone over the chat. The system (300) may further include a play symbol (400) on the combined message (301) to notify that this sticker is also a voice message.

The buttons may be visible on the screen of the user's smartphone or may be invisible; one button may be used to process the functions of all those buttons. The term “displaying” with regard to these buttons is illustrative. The use of these buttons may be done by tapping on or touching a graphic symbol on the screen of the smartphone or physical buttons on it, by tapping on or touching the screen of the smartphone in a certain way, by tilting the smartphone in a certain way, or in any other way that can be used to select an option or to execute an action on mobile devices such smartphones with touch screens and the term tapping in this disclosure and in the claims means any way of activating such buttons. The term ‘displaying a button’ in this disclosure and in the claims means: providing the user with the option to execute the actions that these ‘buttons’ are designed to execute or perform, even though the user's eye doesn't really see a button or anything on the screen. For example, placing three fingers on the screen and quickly sliding them down can cause some action on the device. In addition to that, it is possible that one button will be used to function as two or more of the buttons.

The systems of the present invention can be realized and performed through a feature that the operators of messaging apps can add to their messaging apps by updating their apps for adding the instant pre-prepared sound message keyboard, and/or for enabling to combine a voice message with stickers or images, or by smartphones' manufacturers by upgrading the operations system, or by virtual keyboards providers.

The invention meets a real and specific need, which is not answered by the present art: to have an instant pre-prepared sound messages keyboard that is integrated with the virtual keyboard or with the messaging app, to save ‘on hand’ the instant pre-prepared sound messages that can be sent immediately, for example, by one or two touches on the screen, and to combine a voice message with stickers and images.

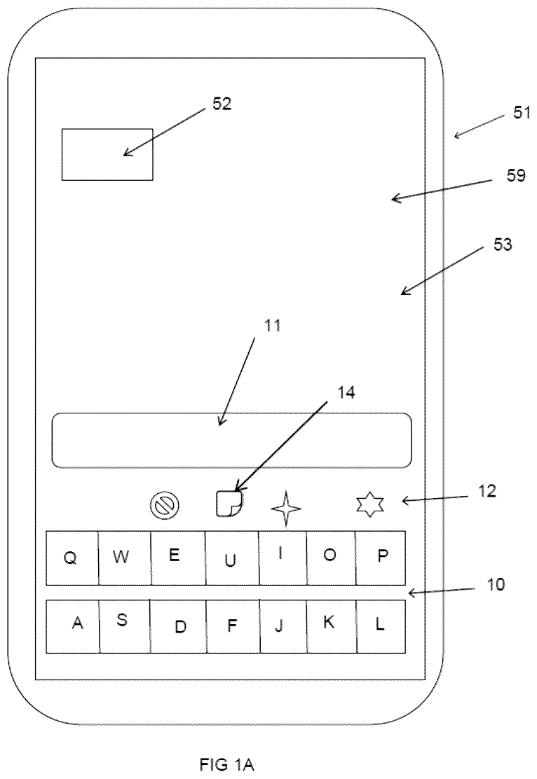

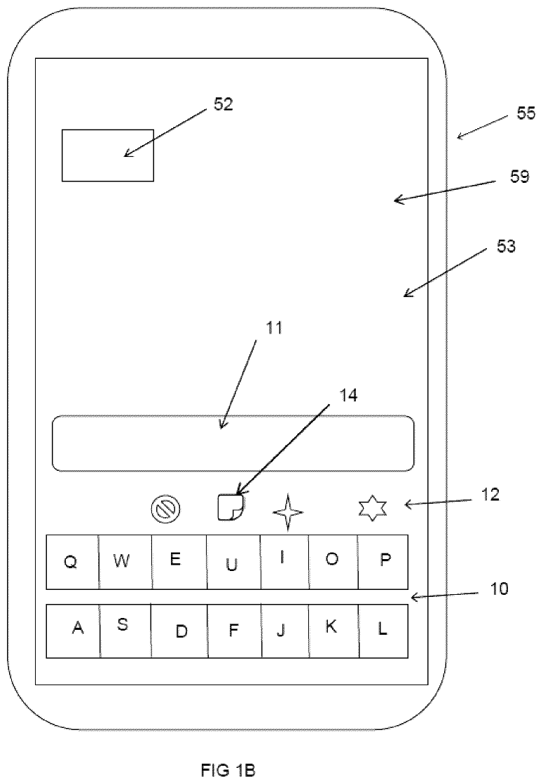

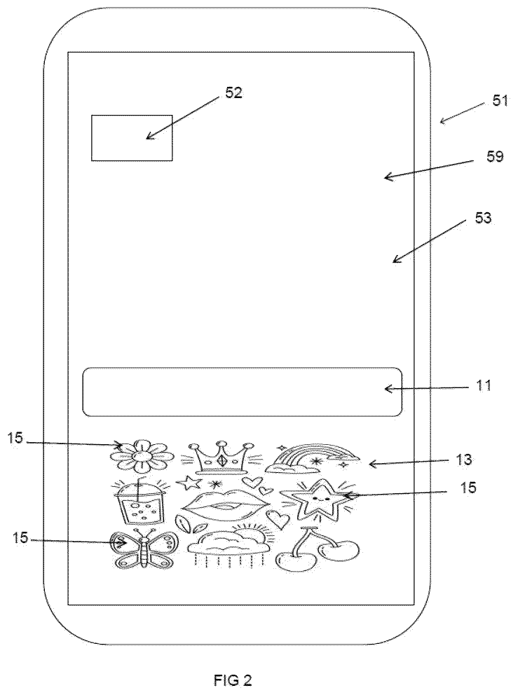

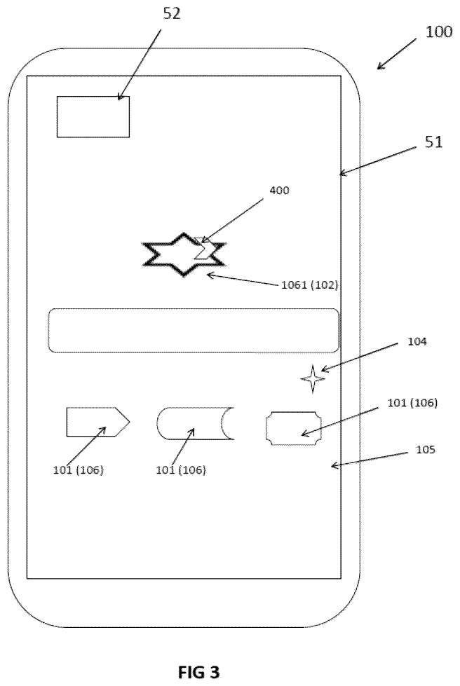

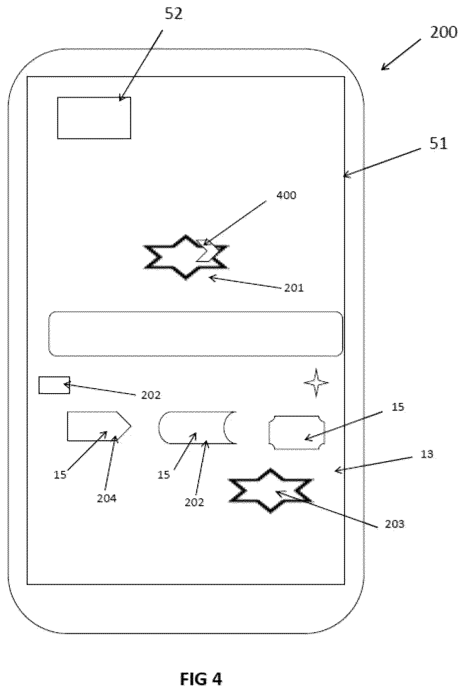

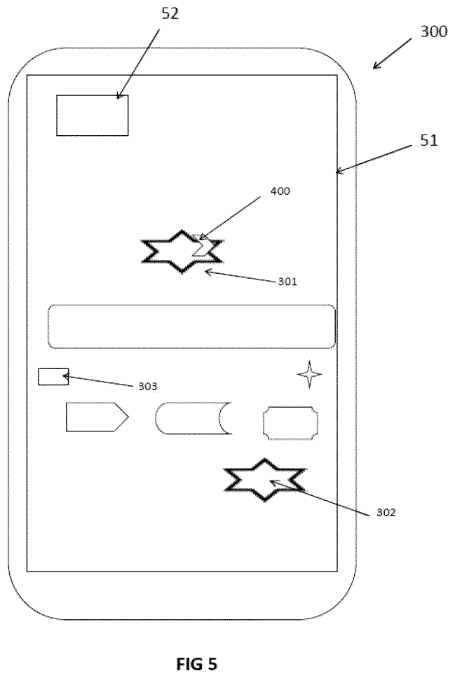

FIG. 1A is a schematic illustration of the user's smartphone; FIG. 1B is a schematic illustration of the contact's smartphone (55); FIG. 2 is a schematic illustration of the user's smartphone with the stickers keyboard (13); FIG. 3 is a schematic illustration of the system (100); FIG. 4 is a schematic illustration of the system (200); and FIG. 5 is a schematic illustration of the system (300).

What is claimed is:

1. A computer system for storing instant sound-sticker messages and for sending a selected instant sound-sticker message over a chat in a messaging app from a user's smartphone to a contact's smartphone that comprises a processing device in the user's smartphone, said computer system is configured to:
display, by said processing device, on a touch screen of the user's smartphone a panel bar display integrated with a virtual keyboard or with the messaging app;
display, by said processing device, on said touch screen a sound-sticker main icon on said panel bar display;
display, by said processing device, on said touch screen a sound-sticker keyboard integrated with said virtual keyboard or with said messaging app that includes said instant sound-sticker messages; wherein said sound-sticker keyboard is designed to be opened upon tapping action on the sound-sticker main icon;
save, by said processing device, on the user's smartphone said instant sound-sticker messages integrated with said virtual keyboard or with the messaging app;
display, by said processing device, on said touch screen a plurality of stickers in the sound-sticker messages keyboard, wherein each of said plurality of stickers is linked to an instant sound-sticker message of said saved instant sound-sticker messages;
select, by said processing device, said selected instant sound-sticker message upon a tapping action on a selected sticker in the sound-sticker messages keyboard that is linked to the selected instant sound-sticker message;
upload, by said processing device, the selected instant sound-sticker message with said selected sticker into said chat, wherein said upload to the chat is configured to cause the user's smartphone to send the selected sticker together with the selected instant sound-sticker message to the contact's smartphone over the chat; or
upload, by said processing device, the selected sticker with the selected instant sound-sticker message into a writing spacebar of said virtual keyboard or said messaging app on the user's smartphone touch screen that is designed to enable the user to send the selected sticker with the selected instant sound-sticker message to the contact's smartphone over the chat.

2. A computer system for creating a combined sticker-voice-message that is designed to be sent over a chat in a messaging app from a user's smartphone to a contact's smartphone that comprises a processing device in the user's smartphone, said computer system is configured to:
display, by said processing device, on a touch screen of the user's smartphone a panel bar display integrated with a virtual keyboard or with the messaging app;
display, by said processing device, on said touch screen a stickers main icon on said panel bar display;
display, by said processing device, on said touch screen a stickers keyboard integrated with said virtual keyboard or with said messaging app, wherein said sticker keyboard is designed to be opened upon tapping action on the sticker main icon;
display, by said processing device, on said touch screen a plurality of stickers in the stickers keyboard;
display, by said processing device, on said touch screen a recording-combining button that is configured to record a voice message and to combine the recorded voice message with a selected sticker of said stickers for creating the combined sticker-voice-message;
upload, by said processing device, the combined sticker-voice-message into the chat, wherein said upload into the chat constitutes an action of sending the selected sticker and the recorded voice message that comprise the combined sticker-voice-message to the contact's smartphone over the chat; or
upload, by said processing device, the combined sticker-voice-message into a writing spacebar of said virtual keyboard or messaging app on the touch screen of the user's smartphone that is designed to enable the user to send the selected sticker and the recorded voice message that comprise the combined sticker-voice-message to the contact's smartphone over the chat.

3. The computer system of claim 2, wherein each of said plurality of stickers comprises said recording-combining button.

4. The computer system of claim 2, wherein each of said plurality of stickers comprises said recording-combining button that is designed to be activated upon a first style tapping action, and comprises a sticker plain send button (204) that is designed to be activated upon a second style tapping action; wherein each sticker is designed to be sent over the chat upon first style taping action, and wherein each sticker is designed to be sent over the chat as a part of a combined sticker-voice-message upon using second style taping action.

5. A computer system for creating a combined image-voice-message that is designed to be sent over a chat in a messaging app from a user's smartphone to a contact's smartphone that comprises a processing device in the user's smartphone, said computer system is configured to:
display, by said processing device, on a touch screen of the user's smartphone a selected image;
display, by said processing device, on said touch screen a recording-combining button that is configured to record a voice message and to combine the recorded voice message with the selected image for creating the combined image-voice-message; and
upload, by said processing device, the combined image-voice-message into the chat, wherein said upload constitutes an action of sending the combined image-voice-message to the contact's smartphone over the chat.
